(19) United States
(12) Patent Application Publication
(10) Pub. No.: US 2025/0065296 A1
(43) Pub. Date: Feb. 27, 2025

(54) METHOD FOR MANUFACTURING A POROUS MONOLITH BY A SOL-GEL PROCESS

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(72) Inventors: Laurent MUGHERLI, Gif-sur-Yvette (FR); Marc MALEVAL, Gif-sur-Yvette (FR); Maartine MAYNE, Gif-sur-Yvette (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(21) Appl. No.: 18/723,732

(22) PCT Filed: Dec. 22, 2022
(86) PCT No.: PCT/EP2022/087504

§ 371 Date: Jun. 24, 2024

(30) Foreign Application Priority Data
Dec. 24, 2021 (FR) FR2114481

(51) Int. Cl. B01J 20/10; B01D 15/10; B01J 20/28; B01J 20/283; B01J 20/30

(52) U.S. Cl. CPC B01J 20/103; B01D 15/10; B01J 20/28042; B01J 20/283; B01J 20/3007; B01J 20/305; B01J 20/3078; B01J 20/3085; B01J 2220/52

(57) ABSTRACT

A method for manufacturing a porous monolith includes: forming a sol including a sol-gel precursor in aqueous solution; at least partially filling with previously formed sol an enclosure and at least one mould contained in the enclosure, the mould including at least one opening into the sol after filling; forming a sol-gel matrix in the enclosure from the sol; removing the mould with the sol-gel matrix contained in the mould from the enclosure; and forming a porous monolith from the sol-gel matrix contained in the mould, wherein the formation of the sol, the sol-gel matrix, and the porous monolith is performed by a sol-gel process.

The present invention relates to a method for manufacturing a porous monolith and its use. It also relates to porous monoliths, in particular obtained by said method, and their use.

### TECHNICAL FIELD

Porous monoliths, in particular hierarchically porous monoliths, present, thanks to their porosity, which is notably multimodal and interconnected, unique material transport properties associated with functionalizable specific surface areas. The skeleton and pore sizes may be adjusted by changing the chemical composition and the parameters of the method used to prepare the materials.

Monoliths are mainly manufactured in cylindrical form with a narrow range of pore size distribution, and can be used for various applications, such as separating, adsorbing or detecting compounds of interest, or catalyzing chemical reactions.

A conventional method for manufacturing porous monoliths, described in particular in the article by Lu et al., JSST 95 (2020) MPH par décomposition spinodale [HPM by spinodal decomposition], consists in setting a solution in a mold during its separation into two bicontinuous phases by a sol-gel process, at a precise moment in this separation in such a way as to obtain a solidified gel in which the solvent-rich phases are separated from the other silica-rich phases, the solvent-rich phases forming the pores and the silica-rich phases forming the skeleton. The solution set in the mold is then extracted from the latter to obtain a porous monolith after drying.

Numerous studies and advances have been made regarding extending the compositions of formulations and understanding the influence of the various constituents of formulations on the structure of porous monoliths by this method. Control of the various levels of porosity has therefore been improved and the surface chemistry has also been diversified through the development of new formulations leading to new materials such as organic-inorganic hybrids or more recently carbon skeletons.

The methods described in the literature are each adapted to precise shapes and sizes of given monoliths, the structure of the monoliths being highly dependent on the formulations, the preparation conditions and the shape of the molds used. It does not appear to be possible to adjust the structure independently of the size or aspect ratio of the final monolith. It is therefore necessary to adapt the formulation to the shape of the mold.

This technical problem of adapting a particular formulation to monoliths of varied sizes and aspect ratios actually leads to problems in terms of obtaining certain sizes, for shapes as simple at first glance as cylinders, in particular cylindrical monoliths with diameters between 0.2 mm and 2 mm, as emphasized in the article by Khoo et al., Talanta 224 (2021), Revue des matériaux pour colonnes chromato [Review of materials for chromatography columns]. This problem is explained in particular by the fact that the manufacture of the monoliths is accompanied by shrinkage owing to the densification of the network and the concomitant expulsion of solvent during the syneresis step, which creates edge heterogeneity on the monolith, as stated in the article by Bruns, S., Müllner, T., Kollmann, M., Schachtner, J., Holtzel, A., & Tallarek, U. (2010). Confocal laser scanning microscopy method for quantitative characterization of silica monolith morphology. Analytical chemistry, 82(15), 6569-6575. This problem of reducing the dimensions of monoliths to submillimeter diameter values proves to be particularly limiting when it is desired to circulate small volumes of liquid within them or integrate them into miniaturized devices.

In addition, current methods offer insufficient reproducibility. Variations are observed in the production of monoliths, even after industrialization, particularly as regards variations observed in the expected retention times when they are used for chromatography.

Thus, it is currently impossible to select a formulation that will result in certain structural properties (skeleton size and porosity), and then obtain, with sufficient reproducibility, monoliths which are identical in terms of structure but have different sizes, distributed over several orders of magnitude, whether with the same shape or with different shapes.

If such technical obstacles, linked to the intrinsic variability of the methods implemented and to shape, were lifted this would open the way to a much wider use of hierarchically porous monoliths given their high potential and their proven efficiency for separation, adsorption and catalysis. More specifically, mastering self-supporting monoliths with submillimeter diameters would make it possible to support ongoing developments in analytical chemistry in terms of analysis throughput and reduction in volumes, for example for applications in the field of health. Lastly, columns, extraction supports, catalysts and microsystems could all be produced by means of a single method, without the need for redeployment of expertise or research to readjust the experimental parameters necessary due to a change in format and/or size of the monolith.

In an attempt to reduce the volume of accessible self-supporting monoliths, particularly in the field of separation, the article by Miyazaki et al., J Chrom. A 1043 (2004) Disques MPH pour SPE [HPM disks for SPE] proposes maintaining a diameter of a few mm and reducing the thickness of the monoliths so as to obtain a monolith in the form of a disk. However, this solution does not allow the thickness to go below one millimeter owing to the fragility of the disk below this value. In addition, the particular shape of the disks is not well suited to the field of separation, the reduction in the height of the monolith resulting in a reduction in the number of theoretical plates and, ultimately, lower separation efficiency.

The article by Motokawa et al., J. Chrom A 961 (2002) Capillaires contenant un MPH [Capillaries containing an HPM] and patent application EP 1 066 513 propose forming the porous monoliths in situ in capillaries, without extracting them. This makes it possible to have a large number of theoretical plates for separation, very useful for HPLC analyses. Such a method does not make it possible to produce self-supporting monoliths of micrometric diameter, which limits the possibilities for integration and use. Moreover, only diameters between 0.025 and 0.2 mm are really accessible using this technique. Scanning electron microscopy images show, on the one hand, that the anchoring of the monoliths in the capillaries is very often incomplete, opening up interstitial spaces which can be detrimental to reproducibility, and indeed to the quality of separation, and on the other hand, that for the same formulation, the structure is not similar. In addition, major modifications must be made to the initial compositions as well as to the steps of the method compared to what is done for larger self-supporting monoliths, in order to limit in particular the edge effects at the wall of the capillary, which makes the preparation of such capillaries lengthy and leads to structural variations. Lastly, the success rate in forming the desired monolith in the capillary by this method is low.

There is therefore a need for a method for manufacturing a porous monolith which is reproducible and allows the size of the porous monoliths to be adapted over a wide range of sizes, in particular at least from 0.025 mm to 5 mm in diameter in the case of cylindrical monoliths, with a well-defined internal structure, in particular controlled pore sizes.

### DISCLOSURE OF THE INVENTION

The invention meets this need by virtue of a method for manufacturing a porous monolith, comprising:
the formation of a sol comprising a sol-gel precursor in aqueous solution,
the at least partial filling, with the sol formed previously, of a container and of at least one mold contained in the container, the mold comprising at least one opening that opens into the sol after filling with sol,
the formation of a sol-gel matrix in the container from the sol,
the extraction from the container of the mold with the sol-gel matrix contained in the mold, and
the formation of a porous monolith from the sol-gel matrix contained in the mold, the formation of the sol, the sol-gel matrix and the porous monolith being performed by a sol-gel process.

“Sol-gel process” means a process implemented using as precursors alkoxides of formula M(OR)n, R′-M(OR)n-1, or sodium silicates or titanium colloids, M being a metal, a transition metal or a metalloid, in particular silicon, and R or R′ being alkyl groups, n being the degree of oxidation of the metal. In the presence of water, there is hydrolysis of the alkoxy groups (OR), forming small particles generally less than 1 nanometer in size. These particles aggregate and form clusters which remain in suspension without precipitating, and form the sol. The increase in clusters and their condensation increases the viscosity of the medium and forms what is called the gel. The gel can then continue to evolve during a phase of aging in which the polymer network present within the gel becomes densified. The gel then shrinks, the solvent being drained from the polymeric network formed, during a step known as syneresis. The solvent then evaporates, during a step referred to as the drying step, which leads to a solid, porous glass-type material resulting in a porous monolith. The syneresis and drying steps may be concomitant.

“The formation of a sol-gel matrix in the container from the sol” means that the sol contained in the container, including in the mold, evolves by the sol-gel process to form a sol-gel matrix. The sol-gel matrix contained in the mold is materially continuous with the sol-gel matrix outside the mold at least through the opening lying below the level of the sol after filling, in such a way as to form a single block.

The presence of at least one opening of the mold below the level of the sol after filling allows the mold to be filled with sol during the filling step and fluidic circulation of sol between the sol contained in the mold and the sol contained in the container during the remainder of the process.

Producing a large sol-gel matrix in the container and extracting a part thereof included in a mold during the formation of the matrix makes it possible to get rid of the edge effects which occur in the methods described above by producing the sol-gel matrix in a container which is always the same size.

Such a method allows the manufacture of porous monoliths with similar textural properties over a wide range of diameters without having to reoptimize, or even modify, the formulation of the initial mixture, whether the monoliths are self-supporting or not.

Such a method also makes it possible to simultaneously form a plurality of porous monoliths having identical textural properties by placing several molds in the container.

It also makes it possible to obtain monoliths with a wide variety of shapes and aspect ratios, as well as varied and reproducible controlled internal structures.

### Sol

Preferably, the sol includes phase separation. Preferably, the sol comprises a pore-forming agent. This facilitates the formation of pores, and in particular allows the formation of macropores, in the sol-gel matrix.

The pore-forming agent may be selected from water-soluble polymers, in particular polyethylene glycol (PEG), poly(acrylic acid), sodium polystyrene sulfonate, poly(ethylene imine) and mixtures thereof. The water-soluble polymer or polymers may have a molecular weight of between 1000 and 100 000 daltons, preferably between 5000 and 50 000 daltons, even better still between 5000 and 30 000 daltons.

The concentration of pore-forming agent, in particular PEG, may be between 0.015 g and 0.35 g per mL of sol, preferably between 0.02 and 0.2 g per mL of sol. These values are linked to the concentration of sol-gel precursor, in particular tetramethoxysilane (TMOS), based on ratios which may be between 0.03 and 1 g of pore-forming agent, in particular PEG, per mL of sol-gel precursor, in particular tetramethoxysilane (TMOS), preferably based on ratios which may be between 0.06 and 0.6 g of pore-forming agent, in particular PEG, per mL of sol-gel precursor, in particular tetramethoxysilane (TMOS).

The sol-gel precursor may be selected from alkoxides, in particular hydrolyzable and condensable organometallics, in particular zirconium alkoxides, in particular zirconium butoxide (TBOZ), zirconium propoxide (TPOZ), alkoxides of titanium, niobium, vanadium, yttrium, cerium, aluminum or silicon, in particular tetramethoxysilane (TMOS), tetraethoxysilane (TEOS), tetrapropoxysilane (TPOS), tetrabutoxysilane (TBOS), trimethoxysilanes, in particular methyltrimethoxysilane (MTMOS), propyltrimethoxysilane (PTMOS) and ethyltrimethoxysilane (ETMOS), triethoxysilanes, in particular methyltriethoxysilane (MTEOS), ethyltriethoxysilane (ETEOS), propyltriethoxysilane (PTEOS), aminopropyltriethoxysilane (APTES), sodium silicates, titanium colloids and mixtures thereof.

The proportion of pore-forming agent in the sol and the proportion of sol-gel precursor in the sol are predetermined based on the characteristics, in particular the total porosity and the average macropore size, of each sol-gel matrix from a sample of known sol-gel matrices after gelation.

“Total porosity” means the ratio of the volume of pores in the sol-gel matrix to the total volume of the sol-gel matrix. This value is between 0 and 1.

The method may include:
the prior formation of a sample of sol-gel matrices each comprising the pore-forming agent and the sol-gel precursor of the monolith to be formed in various known proportions,
the determination, after gelation, of the characteristics, in particular the total porosity and the average macropore size, of each sol-gel matrix of the sample,
the selection of the characteristics, in particular the total porosity and the average macropore size, of the porous monolith to be formed, in particular in accordance with its future use, and
the determination of the proportion of the pore-forming agent in the sol and the proportion of the sol-gel precursor in the sol as a function of the characteristics of the sol-gel matrices of the sample predetermined and of the characteristics selected for the porous monolith to be formed.

The method may include selecting a total porosity for the monolith to be formed and the prior determination of the ratio of the proportion of pore-forming agent and the proportion of sol-gel precursor in the sol as a function of the selected total porosity. The method may include selecting an average macropore size for the monolith to be formed and the prior determination of the proportion of pore-forming agent in the sol as a function of the average macropore size selected. The method may include selecting a total porosity and an average macropore size for the monolith to be formed and the prior determination of the proportion of pore-forming agent and the proportion of sol-gel precursor such that the ratio of the proportion of pore-forming agent and the proportion of sol-gel precursor in the sol correspond to the total porosity selected on a predetermined curve of said ratio as a function of porosity and such that the proportion of pore-forming agent corresponds to the average macropore size selected on a predetermined curve of said proportion as a function of the average macropore size.

The sol may include additives, in particular an acid, in particular acetic acid, or nitric acid, or succinic acid and/or a precursor of an agent for dissolving the sol-gel matrix, in particular urea or compounds bearing amide functions, in particular formamide, acetamide, N-methylformamide (NMF) and mixtures thereof.

The sol may include between 0.001 mol/L and 2 mol/L of acid, particularly acetic acid.

The sol may include between 0.01 and 1.3 g/mL, preferably between 0.01 and 0.4 g/mL, of sol-gel matrix dissolving agent precursor, in particular urea.

Preferably, the sol has a formulation allowing phase separation by spinodal decomposition.

Alternatively, the sol is an emulsion or a templating solution.

### Formation of the Sol

The sol may be formed by stirring a solution comprising the sol-gel precursor, preferably the sol-gel precursor and the pore-forming agent, in particular for a period of greater than or equal to 5 min, better still greater than or equal to 10 min, even better still greater than or equal to 15 min. The duration of stirring may be less than or equal to 3 hours, better still less than or equal to 2 hours. During stirring, the temperature may be controlled at a substantially constant predetermined value, in particular between 0° C. and 90° C., better still between 0° C. and 50° C. This preliminary step of sol preparation makes it possible to initiate the sol gel process before phase separation and to ensure homogeneity of the sol solution when it is transferred into the container without it being any longer necessary to mix it so that the sol sets at a certain degree of phase separation.

### Filling

The container may contain several molds and filling comprises filling the molds with sol, each mold comprising at least one opening that opens into the sol after filling. The molds may or may not be identical. The molds may have different dimensions. This makes it possible to produce several porous monoliths with the same internal structure and the same or different sizes or shapes simultaneously. Filling of the container and of the mold or molds may be carried out by pouring the sol into the mold or molds contained in the container or into the container containing the mold or molds such that the opening is below the level of the sol after filling. Filling may be carried out by pouring the sol into the container, the mold or molds being filled when the level of the sol in the container reaches the opening of the mold or molds. Filling may be carried out by pouring the sol into the mold or molds, the container being filled when the level of the sol in the mold or molds reaches the opening of the mold or molds.

Alternatively, the container and the mold or molds are filled by pouring the sol into the container and then immersing at least partially, preferably gradually, the mold or molds in the sol contained in the container, the or each mold filling with sol through its opening when the level of the sol reaches said opening.

Preferably, after filling, the mold or molds are completely filled with sol.

The mold or molds may be completely immersed in the sol contained in the container after filling.

Alternatively, during filling, the mold or molds are partially immersed in the sol.

The mold or molds may have a single opening. In this case, the opening of the or each mold is preferably oriented in the container toward the opening of the container through which the sol is poured and the mold or molds are preferably completely immersed in the sol after filling.

The mold or molds may have at least two openings, at least one of them being below the level of the sol after filling, the other of the openings of the or each mold lying in the sol or out of the sol after filling.

Preferably, filling is carried out without the presence of air bubbles and/or gradients in chemical composition and/or temperature of the sol in the container and the mold or molds.

### Formation of the Sol-Gel Matrix

The formation of the sol-gel matrix may include condensation so as to form a gel, and optionally at least partial aging to densify the gel. The sol-gel matrix may be formed from the gel after condensation or from the gel after at least partial aging.

Preferably, the formation of the sol-gel matrix in the container does not include drying of the sol-gel matrix.

During condensation, the temperature may be kept substantially constant, in particular at a predetermined temperature of between 15° and 90° C., preferably 25 and 70° C.

Condensation may last more than 10 minutes, better still more than 20 minutes. Condensation may last less than 4 hours, better still less than 2 hours.

The at least partial aging may last at least 1 hour, better still at least 3 hours, and preferably at least 15 hours. The at least partial aging may last less than 2 weeks, in particular less than 72 hours. Preferably, the aging period is sufficiently short to limit the formation of mesopores and/or micropores.

The at least partial aging may be carried out at room temperature.

Preferably, the formation of the sol-gel matrix is carried out in the same way in the container and the mold. The total porosity and the size of the pores are preferably substantially homogeneous in the container and the mold or molds.

### Sol-Gel Matrix

Preferably, the sol-gel matrix obtained by the formation of the sol-gel matrix in the container has macropores, in particular macropores with a dimension greater than or equal to 50 nm. The macropores may have a dimension less than or equal to 10 μm.

Preferably, the pores are connected together in the sol-gel matrix.

Preferably, the concentration of pore-forming agent is selected as a function of the size of the macropores selected for the porous monolith.

Preferably, the ratio between the concentration of pore-forming agent and the concentration of sol-gel precursor is selected as a function of the thickness of the skeleton of the sol-gel matrix selected for the porous monolith.

### Extraction of the Mold

The extraction of the or each mold with the matrix it contains from the container may include extraction of a block of the sol-gel matrix containing the mold or molds from the container and the extraction of the or each mold and the sol-gel matrix it contains from the block previously extracted. The extraction of the or each mold from the block may be carried out by cutting the sol-gel matrix flush with the corresponding mold or breaking the sol-gel matrix surrounding the mold or molds.

Alternatively, the extraction of the or each mold with the matrix it contains may be carried out by removing the corresponding mold from the sol-gel matrix surrounding it after extraction of the block as described above or directly in the container without prior extraction of the block, particularly when the corresponding mold is only partially immersed in the sol-gel matrix.

### Extraction of the Matrix Contained in the Mold

Preferably, the sol-gel matrix contained in the or each mold holds together enough to allow it to be extracted from the mold.

The method may include the extraction of the sol-gel matrix contained in the or each mold from the corresponding mold.

The extraction of the sol-gel matrix contained in the or each mold may be carried out by means of controlled pressure on said sol-gel matrix, for example by direct pressure with a solid of smaller size than the mold or by pressure of a gas with a controlled flow rate.

Alternatively, the extraction of the sol-gel matrix contained in the or each mold is carried out by opening the or each mold, in particular by cutting the or each mold or separating two parts of the or each mold from one another. The mold or molds may be in the form of two parts that are mutually movable, in particular separable or movable relative to one another via a hinge.

The mold or molds containing the sol-gel matrix may be immersed in a liquid during the step of extracting the sol-gel matrix contained in the or each mold. This facilitates the extraction of the sol-gel matrix.

### Generation of the Mesopores

The method may comprise controlled generation of mesoporosity in the sol-gel matrix so as to form a sol-gel matrix with hierarchical porosity. Preferably, this step takes place after the extraction of the or each mold from the container, and before the formation of the porous monolith from the sol-gel matrix of the or each mold. In the case of a plurality of molds, this step may be carried out simultaneously on all the sol-gel matrices obtained or separately under substantially identical or different conditions of controlled generation of mesoporosity.

Preferably, the pore size obtained is less than or equal to 50 nm, better still between 2 and 50 nm.

This makes it possible to obtain hierarchically porous monoliths, that is to say having at least two orders of magnitude of pore sizes, preferably macropores formed during the formation of the sol-gel matrix and mesopores formed during the controlled generation of mesopores. Such porous monoliths have a large internal surface area, which increases the surface areas for exchange between the liquid passing through it and its material and minimizes the distances to be covered by diffusion. In addition, this provides flexibility to the sol-gel matrix while reducing the risk of breakage. It also reduces the drying time of the sol-gel matrix.

The controlled generation of mesoporosity may be performed in the sol-gel matrix while still in the mold. The sol-gel matrix with hierarchical porosity may be extracted from the mold or not. Alternatively, the controlled generation of mesoporosity is performed after extraction of the sol-gel matrix from the mold.

The controlled generation of mesoporosity may be performed by immersion of the sol-gel matrix, whether or not extracted from the or each mold, in an aqueous solution for generating mesoporosity comprising an agent for dissolving the sol-gel matrix and/or a precursor of an agent for dissolving the sol-gel matrix.

The dissolving agent may be ammonium hydroxide, for example at a concentration of 1M, sodium hydroxide, or hydrofluoric acid or mixtures thereof.

The sol-gel matrix dissolving agent precursor may be urea or compounds bearing amide functions, in particular formamide, acetamide, N-methylformamide (NMF) and mixtures thereof.

The quantity of sol-gel matrix dissolving agent precursor is between 0.01 and 1.3 g per mL of initial sol, preferably between 0.01 and 0.4 g per mL of initial sol.

The solution for generating mesoporosity may comprise a sol-gel matrix dissolving agent precursor as described above and a dissolving agent as described above.

Preferably, in the case where the solution for generating mesoporosity comprises a sol-gel matrix dissolving agent precursor, the solution for generating mesoporosity is heated to a temperature above room temperature.

Preferably, the concentration of dissolving agent and/or dissolving agent precursor is such that it allows localized dissolution of the sol-gel matrix or matrices in such a way as to form mesopores in the latter without dissolving the sol-gel matrix or matrices overall. The ratio between the volume of dissolving agent and/or dissolving agent precursor and the volume of the sol-gel matrix may be selected as a function of the duration of the step of controlled generation of mesoporosity, the temperature at which this step is carried out, and the concentration of dissolving agent.

Such methods make it possible to obtain mesopores of perfectly controlled size.

Preferably, the controlled generation of mesoporosity lasts for less than 50 hours, better still less than 20 hours. The controlled generation of mesoporosity may last for more than 0.5 hour, better still more than 10 hours, even better still more than 20 hours. During this step, the temperature of the sol-gel matrix may be greater than or equal to 30° C., better still greater than or equal to 60° C. and/or less than or equal to 150° C., better still less than or equal to 120° C. The temperature may be kept substantially constant during this treatment. This step may be carried out in an autoclave.

Alternatively, the method does not involve any generation of mesoporosity.

### Formation of the Monolith

In the case of a plurality of molds, the formation of the monolith may be carried out simultaneously on all the sol-gel matrices obtained.

The formation of the porous monolith may involve at least partial aging to densify the sol-gel matrix, particularly when aging has not taken place completely beforehand.

The formation of the porous monolith may include drying of the sol-gel matrix, whether or not extracted from the or each mold, to form a dried sol-gel matrix. The drying step may be carried out under a flow of air or inert gas, in particular dinitrogen, argon or carbon dioxide, helium, or dioxygen or dihydrogen.

Drying preferably takes place after the controlled generation of mesoporosity, when the latter takes place.

The drying step may last at least 5 hours and/or less than 20 hours.

The drying step may be carried out in critical conditions, better still supercritical conditions, in particular in an autoclave or a freeze dryer.

The formation of the porous monolith may include heat treatment of the sol-gel matrix or matrices, whether or not extracted from the or each mold, particularly after drying. The heat treatment may be carried out in a closed container under a flow of air or inert gas, in particular dinitrogen, argon or carbon dioxide, helium, or dioxygen or dihydrogen, and by gradual heating followed by maintaining the final temperature for a predetermined time. The gradual heating may consist of an increase of 0.5° C./min until a temperature greater than or equal to 300° C., better still greater than or equal to 340° C., for example substantially equal to 350° C., is reached, so as to obtain a porous monolith. The final temperature may be maintained for more than 1 hour. This makes it possible to stabilize the structure of the monolith and to eliminate organic residues resulting from the synthesis.

In the case where the sol-gel matrix is extracted from the or each mold, this is advantageously done before the formation of the porous monolith.

### Container

The container may include a system for controlling the temperature within the container.

Preferably, the container is configured to contain a plurality of molds.

The container may be cylindrical or conical, in particular with a polygonal, oval, ovoid or circular base.

The container may be made of plastic, in particular polytetrafluoroethylene (PTFE), polypropylene (PP), polyethylene (PE), polycarbonate (PC), polyethylene terephthalate (PET), polyvinyl chloride (PVC), or glass or stainless steel.

The volume of the container may be greater than or equal to 0.5 mL.

### Mold

Preferably, the mold or molds are entirely contained in the container. Alternatively, the mold or molds may protrude from the container.

The mold or molds may have a single opening. Preferably, they are then entirely contained in the container and filling with sol is preferably carried out by filling the mold or molds, filling of the container taking place when the level of the sol reaches the opening of the mold or of at least one mold. In this case, the mold or molds are preferably completely immersed in the sol after filling.

The mold may have at least two openings. It is then possible to fill the mold or molds with sol by filling the container with sol and the mold or molds may be completely or partially immersed in the sol as long as at least one of the openings of the or each mold opens into the sol after filling.

Preferably, the mold or molds are positioned in the container such that one of the openings lies on the lowest surface of the mold or molds in the container.

The mold or molds may be made of plastic, in particular polytetrafluoroethylene (PTFE), polyetheretherketone (PEEK), polyethylene (PE), polypropylene (PP), or polylactic acid, or glass, in particular fused silica or borosilicate, or stainless steel. The mold or molds may be formed by 3D printing or casting.

The mold or molds may consist of a porous body.

The or at least one mold, better still each mold, may be a hollow cylinder, in particular a cylinder of revolution.

The or at least one mold, better still each mold, may be open at its two opposite ends. The or each mold may be positioned in the container with its longitudinal axis extending vertically in the container.

The or at least one mold, better still each mold, may have a cavity with a largest transverse dimension, specifically a diameter, of less than or equal to 100 mm, better still less than or equal to 20 mm, even better still less than or equal to 13 mm, better still less than or equal to 8 mm and/or greater than or equal to 0.025 mm.

The volume of the or each mold may be greater than or equal to 10 nL and/or less than or equal to 400 mL, better still between 30 nL and 100 mL. The or at least one mold, better still each mold, may have a height greater than its largest transverse dimension, in particular its diameter.

The or at least one mold, better still each mold, may have two openings extending on opposite walls.

The or at least one mold, better still each mold, is hollow and may be spherical, cylindrical or conical, in particular cylindrical or conical with a polygonal, oval, ovoid or circular base. The mold or molds may have at least one open end, better still two opposite open ends, forming the opening or openings, in particular in the form of a tube open at its two ends.

The openings may have a circular contour.

The method may exclude a step of extracting the sol-gel matrix from the mold or from each mold, the mold forming a casing for the porous monolith. The mold may be, in this case, a capillary, or made of a heat-shrinkable material, or a pipette tip.

### Capillary

The mold may be a capillary having an inside diameter of between 5 μm and 3 mm, better still between 25 μm and 500 μm.

The capillary may be made of fused silica. The capillary may have an internal surface activated via a previous activation step.

In this case, the method may exclude a step of extracting the sol-gel matrix from the capillary.

When the porous monolith is in the capillary in which it was formed, the manufacturing method excludes a step of shrinking, in particular heat-shrinking, of the mold, in particular of the capillary, on the porous monolith.

In this case, the generation of mesoporosity is preferably performed, where applicable, by heating the capillary in an aqueous solution containing a dissolving agent precursor, in particular urea, in particular as described above.

### Monolith

Preferably, the sol-gel matrix is extracted from the mold or from each mold and the porous monolith obtained is self-supporting.

Preferably, the porous monolith is a hierarchically porous monolith.

The porous monolith or monoliths may have a diameter of less than or equal to 10 mm, better still less than or equal to 6 mm and/or greater than or equal to 0.02 mm.

Preferably, the porous monolith is self-supporting and has a diameter of less than or equal to 1 mm or the porous monolith is in a capillary and has a diameter of greater than or equal to 0.2 mm.

The porous monolith may comprise macropores, i.e. having a dimension greater than or equal to 50 nm, and mesopores, i.e. having a dimension between 2 and 50 nm.

The porous monolith may have a substantially homogeneous structure throughout its volume.

The porous monolith may have an aspect ratio, defined as its height over its largest transverse dimension, of greater than or equal to 0.2, better still greater than or equal to 0.4, better still greater than or equal to 1 and/or less than or equal to 1000, better still less than or equal to 500, even better still less than or equal to 100, better still less than or equal to 50, even better still less than or equal to 20.

Preferably, the porous monolith is cylindrical with a polygonal, oval or circular base, in particular cylindrical of revolution.

The monolith may be self-supporting and the method may include inserting the self-supporting porous monolith into a heat-shrinkable tube, pipette tip or solid phase extraction cartridge and heating the heat-shrinkable tube to encapsulate the porous monolith in said tube in the case of a heat-shrinkable tube.

The method may include modifications to the porous monolith post-manufacturing, in particular functionalization of the surface of the porous monolith. The surface of the porous monolith may be covered with molecules such as hydrophobic hydrocarbon ligands (e.g. octadecyl ligands) or hydrophilic ligands such as 2,3-dihydroxypropyl derivatives. The ligands of such modified columns may be further modified using known procedures. Porous catalysts or enzyme supports may be prepared by adding enzymes, for example glucose isomerase, or catalytic metal elements, for example platinum and palladium.

The invention also relates to a self-supporting porous monolith, in particular obtained using the method as described above, having a largest transverse dimension strictly smaller than 1 mm.

The self-supporting porous monolith may have a largest transverse dimension greater than or equal to 20 μm.

Preferably, the porous monolith is a hierarchically porous monolith.

The porous monolith may comprise macropores, i.e. having a dimension greater than or equal to 50 nm, and mesopores, i.e. having a dimension between 2 and 50 nm.

The porous monolith may have a substantially homogeneous porosity throughout its volume.

The porous monolith may have an aspect ratio of greater than or equal to 0.2, better still greater than or equal to 0.4 and/or less than or equal to 1000, better still less than or equal to 100, even better still less than or equal to 50, preferably less than or equal to 20.

Preferably, the porous monolith is cylindrical with a polygonal, oval or circular base, in particular cylindrical of revolution.

The invention also relates to an assembly of a mold, in particular a capillary, and a porous monolith contained in the mold in particular obtained using the method as described above, comprising a largest transverse dimension strictly greater at 200 μm.

Preferably, the porous monolith fills at least one cross section of the mold and is manufactured in the mold without a step of shrinking, in particular heat shrinking, of the mold on the porous monolith.

When the porous monolith is in the mold in which it was formed, the porous monolith may have a cross section substantially equal to the internal cross section of the mold, in particular of the capillary, over its entire length, including over sections thereof that are free of porous monolith.

Preferably, the porous monolith is a hierarchically porous monolith.

The porous monolith may comprise macropores, i.e. having a dimension greater than or equal to 50 nm, and mesopores, i.e. having a dimension between 2 and 50 nm.

The porous monolith may have a substantially homogeneous porosity throughout its volume.

Preferably, the assembly is characterized in that it does not have a continuous fluidic path extending between the wall of the capillary and the porous monolith connecting portions of capillaries over lengths at least 20 times greater than the average macropore size, better still over lengths at least 10 times greater than the average macropore size.

Preferably, the mold, in particular the capillary, has not undergone deformation, in particular deformation by heating during the formation of the assembly. Preferably, the mold, in particular the capillary, does not exert a compressive force on the porous monolith, in particular as a result of a shrinking step during the formation of the assembly.

When the porous monolith is in the capillary in which it was formed, the manufacturing method excludes a step of shrinking, in particular heat-shrinking, of the mold, in particular of the capillary, on the porous monolith.

The porous monolith may have an aspect ratio of greater than or equal to 0.2, better still greater than or equal to 0.4 and/or less than or equal to 1000, better still less than or equal to 100, even better still less than or equal to 50, preferably less than or equal to 20.

Preferably, the porous monolith is cylindrical, in particular cylindrical of revolution.

### Use

The invention also relates to a method for liquid phase chromatography, separation and/or extraction and/or adsorption of compounds of interest in complex liquid mixtures, filtration of a liquid, or catalysis of a liquid by passing the liquid through a porous monolith obtained by the method described above or a porous monolith as described above.

Said method may include integrating the self-supporting monolith into a heat-shrinkable tube and integrating the tube into a fluid flow system.

### BRIEF DESCRIPTION OF THE DRAWINGS

FIG. 1 schematically depicts the various steps in the method for manufacturing a porous monolith according to the invention,

FIG. 2 illustrates examples of a self-supporting porous monolith manufactured by the manufacturing method according to the invention,

FIG. 3 shows images obtained with a scanning electron microscope for monoliths of different diameters,

FIG. 4 is a graph showing pore volume in relation to pore diameter in a porous monolith,

FIG. 5 shows the steps in the separation of a mixture of dyes in a porous monolith obtained by the method according to the invention,

FIG. 6 is a ternary diagram showing the molar proportion of PEG as a function of the molar proportion of solvent (including water, alcohol formed and catalyst) and the molar proportion of gel (SiO2) formed in the sol-gel matrix at the end of gelation, and

FIG. 7 is a cross-sectional view of a monolith measuring 800 μm in diameter formed by the method of the invention.

### DETAILED DESCRIPTION

FIG. 1 depicts the various steps in a method for manufacturing a porous monolith.

The method comprises a first step, not shown, of forming an aqueous solution of a pore-forming agent and a sol-gel precursor and possible additives, in particular an acid and/or a matrix dissolving agent.

The pore-forming agent may be selected from water-soluble polymers, in particular polyethylene glycol (PEG), poly(acrylic acid), sodium polystyrene sulfonate, poly(ethylene imine).

The water-soluble polymer or polymers may have a molecular weight of between 1 000 and 100 000 daltons, preferably between 5 000 and 50 000 daltons, even better still between 5 000 and 30 000 daltons.

The concentration of pore-forming agent, in particular PEG, may be between 0.015 g and 0.35 g per mL of sol, preferably between 0.02 and 0.2 g per mL of sol. These values are linked to the concentration of sol-gel precursor, in particular tetramethoxysilane (TMOS), based on values of 0.03 to 1 g of pore-forming agent, in particular PEG, per mL of sol-gel precursor, in particular tetramethoxysilane (TMOS), preferably based on values from 0.06 to 0.6 g of pore-forming agent, in particular PEG, per mL of sol-gel precursor, in particular tetramethoxysilane (TMOS). It is selected according to the size of the macropores desired for the final porous monolith.

The sol-gel precursor may be selected from alkoxides, in particular hydrolyzable and condensable organometallics, in particular zirconium alkoxides, in particular zirconium butoxide (TBOZ), zirconium propoxide (TPOZ), alkoxides of titanium, niobium, vanadium, yttrium, cerium, aluminum or silicon, in particular tetramethoxysilane (TMOS), tetraethoxysilane (TEOS), tetrapropoxysilane (TPOS), tetrabutoxysilane (TBOS), trimethoxysilanes, in particular methyltrimethoxysilane (MTMOS), propyltrimethoxysilane (PTMOS) and ethyltrimethoxysilane (ETMOS), triethoxysilanes, in particular methyltriethoxysilane (MTEOS), ethyltriethoxysilane (ETEOS), propyltriethoxysilane (PTEOS), aminopropyltriethoxysilane (APTES) and mixtures thereof, for example TMOS. It is also possible to use precursors such as sodium silicates or titanium colloids, particularly if the purity requirements allow, i.e. are not too high.

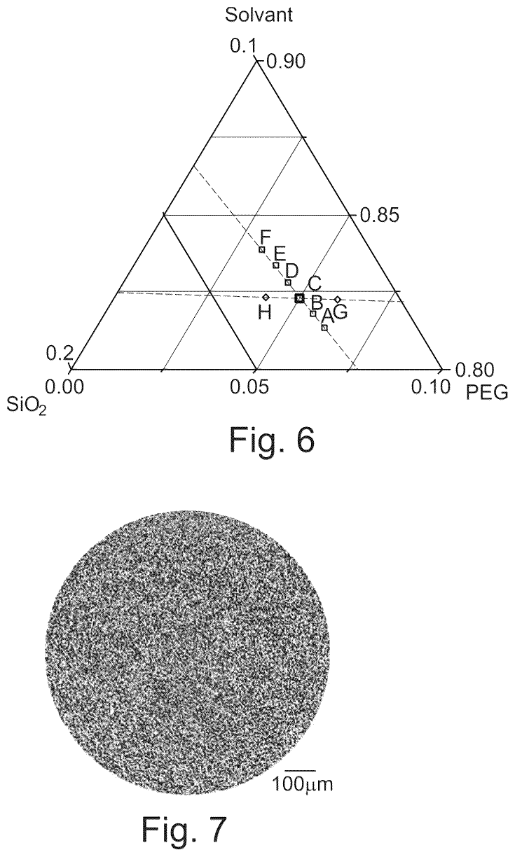

The proportion of pore-forming agent in the sol and the proportion of sol-gel precursor in the sol are predetermined based on the characteristics, in particular the total porosity and the average macropore size, of a sample of known sol-gel matrices taken just after gelation. This is shown in particular in FIG. 6, which is a ternary diagram having as data the proportion of pore-forming agent (in this case PEG), the proportion of gel in the matrix (the proportion of SiO₂ formed by gelation of TMOS) and the proportion of solvent (including water, alcohol produced and catalyst). The sum of these three data is always 100%. The sol-gel matrices A to H with different percentages of the aforementioned data were formed. The total porosity and average macropore size formed in each of the sol-gel matrices were determined. The sol-gel matrices A to F all have the same proportion of gel in the matrix (SiO2) but have different proportions of pore-forming agent, notably decreasing from A to E. It can be seen that the average pore size increases from A to E, at a substantially constant total porosity. The sol-gel matrices G, C and H have substantially the same quantity of solvent but have different ratios of the quantity of pore-forming agent to the quantity of gel (SiO2) in the sol-gel matrix, notably decreasing from G to C to H. It can be seen that the total porosity decreases from G to C to H, at a substantially constant pore size. Thus, for a pore-forming agent/sol-gel precursor pair, it is easy to determine the proportions of pore-forming agent and sol-gel precursor that allow the formation of a porous monolith having a particular total porosity and average macropore size.

The solution is then stirred for a predetermined duration of between 5 min and 3 hours, even better still between 15 min and 2 hours, at a controlled, substantially constant temperature of between 0° C. and 90° C., better still between 0° C. and 50° C. This stirring step makes it possible to initiate the sol gel process for forming a sol 5 before phase separation.

The sol 5 is then added, in step 20, to a container 12 so as to at least partially fill said container 12 and at least one mold 15 contained in the container 12.

The mold 15 may be positioned in the container which is gradually filled with sol 5 in such a way that the mold 15 gradually fills without the presence of air bubbles or a chemical composition gradient. Filling may be carried out until the mold 15 is completely immersed. Partial immersion is also possible. It is also possible to add the mold to the sol 5 contained in the container 12.

The container 12 may be configured to contain a plurality of molds 15, identical or non-identical. The container 12 may be cylindrical as shown or may have any other shape. The container 12 may be made of plastic, in particular PTFE, PP, PE, PC, PET, PVC, or glass or stainless steel.

The mold or molds 15 have two openings 17 and 18 on opposite surfaces of the mold 15, at least one of the two openings 17 lying below the level of the sol after filling. Such openings allow filling of the mold or molds 15 by filling the container 12 containing the mold or molds 15 or by at least partial immersion of the mold or molds 15 in the sol 5 contained in the container 12 and circulation of the sol 5 between the inside and outside of the mold or molds before total condensation thereof. In the example illustrated, the mold or molds 15 are in the form of tubes open at their two ends and extend vertically in the container 12, but it could be quite different, the tube could be oriented in the container differently and/or the mold could have another shape.

The mold or molds 15 may be entirely contained in the container 12, as shown, or protrude from the latter. In the case of the former, the mold or molds 15 may or may not be immersed entirely in the sol 5 after filling.

The mold or molds 15 may be made of plastic, in particular PTFE, PEEK, PE, PP, or polylactic acid or glass or stainless steel, in particular fused silica or borosilicate.

The mold or molds may consist of a porous body.

The mold or molds may be formed by 3D printing or casting.

The largest transverse dimension of the cavity of the mold or molds 15, in particular the diameter d of this cavity, may be between 13 mm and 0.025 mm.

Once the sol 5 has been placed in the container 10 and the mold or molds 15, condensation takes place in step 30 throughout the container and the mold. This sol-gel transition may be followed by at least partial maturation (or aging) of the whole. This step ensures the formation of homogeneous macropores of a similar nature in the sol-gel matrix formed 22, regardless of its shape and size.

During condensation, the temperature may be kept substantially constant, in particular between 15° and 90° C., preferably 25 and 70° C., for a period of between 10 min and 4 hours. The duration of condensation and the predetermined temperature depend on the internal structure of the desired sol-gel matrix and the duration of stirring of the initial solution in the sol formation step.

The at least partial aging may last between 30 minutes and 2 weeks, notably less than 72 hours at room temperature. Preferably, the aging period is sufficiently short to prevent the formation of mesopores and/or micropores.

A block 22 of sol-gel matrix containing the mold 15 is then extracted from the container 12 in step 40. In the case where the mold 15 is only partially immersed, this step may be optional as will be seen below.

The mold 15 with the sol-gel matrix 25 it contains is then extracted from the porous solid in step 50, for example by cutting the sol-gel matrix of the block 22 flush with the mold then removing the mold 15 with the sol-gel matrix 25 it contains, or by breaking the sol-gel matrix of the block 22 around the mold 15. In the case where the immersion was partial, it is possible to directly remove the mold 15 with the sol-gel matrix 25 it contains from the block previously extracted or directly from the container 12.

The sol gel matrix 25 may then be extracted from the mold 15 in step 50. This is achieved by means of controlled pressure exerted on the sol-gel matrix 25 while holding the mold 15. The pressure may be obtained either with a solid made of plastic or glass, such as a fused silica capillary for example, or any other fairly robust material of smaller size than the mold 15, or with a gas with a controlled flow rate. The extraction operation may be facilitated by immersing the mold 15 and sol-gel matrix 25 assembly in a liquid. It is optionally possible to generate a slight difference in pressure by gently tapping the mold 15 and sol-gel matrix 25 assembly to extract the sol-gel matrix 25. Alternatively, the sol-gel matrix 25 is kept in the mold 15, particularly in cases where the largest transverse dimension of the mold is small, in particular between 0.02 mm and 0.3 mm.

Once the mold 15 with the sol-gel matrix 25 it contains has been extracted from the block 22 or from the container, or the sol-gel matrix 25 has been extracted from the mold 15, the method may include a step of controlled generation of mesoporosity. This step may be carried out by immersing the sol-gel matrix 25 or the mold/sol-gel matrix assembly in a basic solution, for example a 1M ammonium hydroxide solution, or by heating the material in water in the presence of a precursor, for example urea to generate ammonia in situ. Note that in the second method, it is possible to add ammonium hydroxide. This operation may last between 0.5 hours and 50 hours at a predetermined, substantially constant temperature of the sol-gel matrix of between 30° C. and 150° C. This step may be carried out on several sol-gel matrices simultaneously, i.e. in the same bath, whether or not they are from the same block.

Preferably, the pore size obtained is less than or equal to 50 nm, better still between 2 and 50 nm.

The sol-gel matrix or matrices obtained or the mold or molds with the sol-gel matrix they contain are then dried. To this end, they are placed in a closed vessel, in particular an autoclave, so as to be dried in critical or supercritical conditions, in particular under a flow of air or inert gas, in particular dinitrogen (N₂) for a period of time of between 10 and 20 hours. They are then subjected to a gradient of 0.5° C./min until they reach 350° C. with a plateau of a few hours at this last temperature, under a flow of inert gas (other gases may be used). These steps may be carried out on several sol-gel matrices simultaneously, i.e. in the same closed vessel, whether or not they are from the same block.

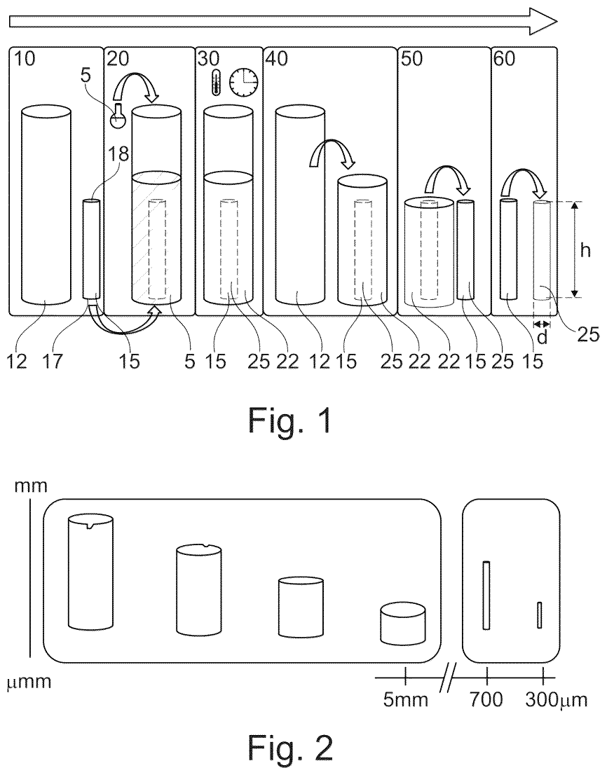

Ready-to-use monoliths are thus obtained. Examples of monoliths of different diameters and heights are shown in FIG. 2. These monoliths are all made simultaneously with molds of different sizes from a sol as described in the example below.

The porous monolith or monoliths obtained may comprise macropores, i.e. having a selected dimension greater than or equal to 50 nm, and mesopores, i.e. having a selected dimension of between 2 and 50 nm.

The porous monolith or monoliths may have a substantially homogeneous structure throughout its volume, as can be seen in FIG. 7.

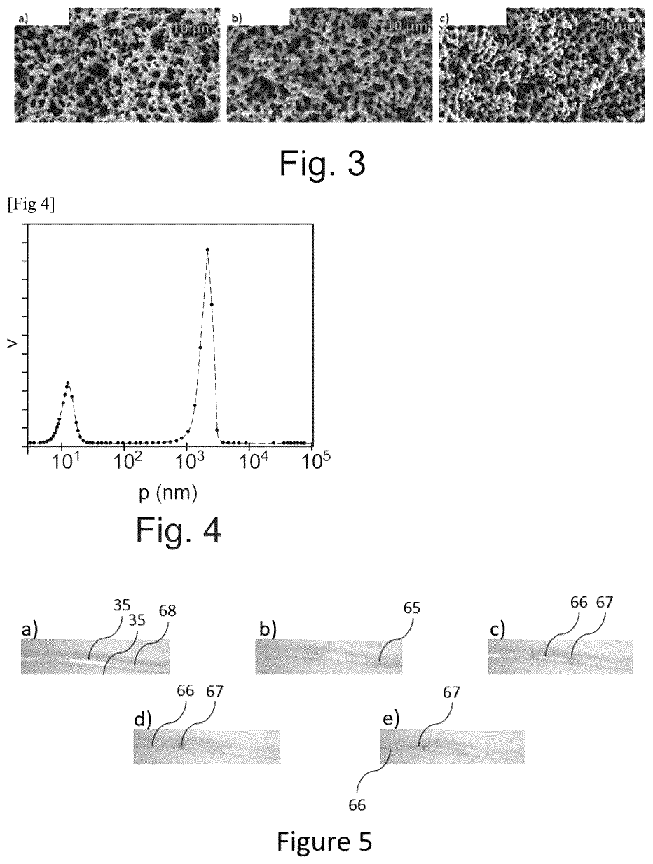

The macroporosity for different monolith diameters obtained with different molds of different sizes in the same container, observed with a scanning electron microscope (SEM), is shown in FIG. 3. Image a) corresponds to a porous monolith measuring 5 mm in diameter, image b) to a porous monolith measuring 0.8 mm in diameter and image c) corresponds to a porous monolith measuring 0.3 mm.

FIG. 4 depicts the distribution of pore diameters p in nanometers of a porous monolith according to the example below with a step of controlled generation of mesoporosity as a function of the pore volume V. It can be seen in this graph that the distribution of pore diameters p mainly has two pore diameters p, one of around 20 nm corresponding to the mesopores and one of around 2 μm corresponding to the macropores. This graph demonstrates that the present method allows precise control of the pore diameters in the porous monolith

The porous monolith or monoliths may have an aspect ratio, defined as its height over its largest transverse dimension, of between 0.2 and 100.

The monolith or monoliths may be self-supporting and the method may include inserting the or each self-supporting porous monolith into a heat-shrinkable tube or pipette tip and heating the heat-shrinkable tube to encapsulate the porous monolith in said tube in the case of a heat-shrinkable tube.

The method may include modifications to the porous monolith post-manufacturing, in particular functionalization of the internal surfaces of the porous monolith. Functionalization may be carried out using liquid phase or gas phase processes, using organosilanes, in particular chlorosilanes (e.g. octadecyltrichlorosilane) and alkoxysilanes (octadecyltriethoxysilane, aminopropyltriethoxysilane, propyltrimethoxysilane), or hexadimethylsilazane.

The porous monolith obtained may then be integrated into a fluid flow system, for example using a heat-shrinkable tube, for example made of polytetrafluoroethylene (PTFE).

Alternatively, the mold may be a fused silica capillary having an inside diameter of between 5 μm and 3 mm, better still between 5 μm and 500 μm. In this case, the method may exclude a step of extracting the sol-gel matrix from the capillary. The capillary may have an internal surface activated via a previous activation step.

In this case, the generation of mesoporosity and/or microporosity is preferably carried out by heating the capillary in water containing a precursor, in particular urea as described above.

Alternatively, the mold or molds may have only one opening. The latter opens into the sol after filling to allow circulation of the sol between the mold and the container.

Alternatively, the initial solution may be an emulsion or a templating solution containing sol-gel precursors.

### EXAMPLE

The synthesis of self-supporting monoliths measuring approximately 800 μm in diameter, having macropores of approximately 2 μm and mesopores of approximately 15 nm generated by immersion in a basic solution, is described in detail below. In this example, several monoliths (at least ten or so) are manufactured simultaneously by placing several molds in a container.

A solution is prepared by mixing 0.33 g of PEG with 2 mL of TMOS in 4 mL of 0.01 M acetic acid. The solution is stirred at 0° C. for 30 min to form a sol then transferred to a container made of polypropylene (PP) in which PTFE tubes of approximately 1 mm in diameter have been previously positioned vertically. Filling is carried out by gradually adding sol into the container from the lowest point using a micropipette. The quantity of solution added is such that the molds are completely immersed.

The container is placed at a temperature of 40° C., and gelation occurs between 45 to 50 min after transfer into the container. After gelation has taken place, the gel is left to age for 24 hours at 40° C. The sol-gel matrix resulting from gelation and maturation is then extracted from the container and broken with metal pliers to recover the molds which were incorporated therein. The monolithic sol-gel matrices encapsulated in the molds are then extracted with the aid of manual pressure exerted by a tube with a diameter of less than 1 mm. For this protocol, this pressure from a solid tube is sufficient to extract the monoliths and does not weaken the gel.

The sol-gel matrices obtained are quickly immersed in a 1M NH₄OH solution, adhering to a ratio of approximately 5 between the volumes of basic solution and the volume taken up by the sol-gel matrix.

The matrices obtained are then placed in an autoclave. The latter is placed in an oven and connected by tubes which allow circulation of gas. The gels are then dried for 12 hours under N₂. Lastly, a heat treatment is carried out with a gradient of 0.5° C./min to 350° C. and a plateau of 2 hours at this last temperature.

The monoliths obtained are for example used to overcome certain limitations intrinsic to solid phases consisting of particles compacted between two frits, for example in the field of liquid phase chromatography, or for the separation/extraction of compounds of interest present in complex mixtures. The benefit of these materials has also been demonstrated in the field of catalysis.

In FIG. 5, the use of one of the previously manufactured porous monoliths 35 for the separation of two dyes from a mixture of two dyes 65 is shown.

In photo a), the porous monolith 35 is introduced into a heat-shrinkable tube 68 which is heated. The assembly of the heat-shrinkable tube 68 integrating the porous monolith 35 is integrated into a fluid flow system and the mixture of two dyes 65 is introduced by the fluid flow system into the heat-shrinkable tube 68 at one of the ends of the porous monolith, in photo b). It is loaded into the porous monolith 35. When it is loaded into the porous monolith, a separation of the two dyes, a yellow dye 66 at the head and a blue dye 67 at the tail, is observed as shown in photo c). At the outlet of the porous monolith, after drying and elution, the yellow dye 66 comes out first as shown in photo d) and the blue dye 67 then comes out as shown in photo e). The two dyes 66 and 67 are well separated at the output.

The invention is not limited to the examples which have just been described. The mold or molds may be different as long as they can be filled with sol and be in fluidic communication with the sol contained in the container.

1. A method for manufacturing a porous monolith, comprising:
the formation of a sol comprising a sol-gel precursor in aqueous solution,
the at least partial filling, with the sol formed previously, of a container and of at least one mold contained in the container, the mold comprising at least one opening that opens into the sol after filling with sol,
the formation of a sol-gel matrix in the container from the sol,
the extraction from the container of the mold with the sol-gel matrix contained in the mold, and
the formation of a porous monolith from the sol-gel matrix contained in the mold,
the formation of the sol, the sol-gel matrix and the porous monolith being performed by a sol-gel process.

2. The method as claimed in claim 1, wherein the sol includes phase separation.

3. The method as claimed in claim 1, wherein the sol may be formed by stirring a solution comprising the sol-gel precursor.

4. The method as claimed in claim 1, wherein the mold or molds have at least two openings, at least one of the openings of the or each mold opening into the sol after filling.

5. The method as claimed in claim 1, wherein the or at least one mold is a hollow cylinder.

6. The method as claimed in claim 1, wherein the container contains several molds and filling comprises filling the molds, each mold comprising at least one opening that opens into the sol after filling, filling of the container and of the mold or molds being carried out by pouring the sol into the mold or molds contained in the container or into the container containing the mold or molds such that the opening is below the level of the sol after filling, or filling of the container and of the mold or molds is carried out by pouring the sol into the container, and then immersing at least partially the mold or molds in the sol contained in the container, the or each mold being filled with sol via one of its openings when the level of the sol reaches said opening.

7. The method as claimed in claim 1, wherein the extraction of the or each mold with the sol-gel matrix it contains from the container may include extraction of a block of the sol-gel matrix containing the mold or molds from the container and the extraction of the or each mold and the sol-gel matrix it contains from the block previously extracted.

8. The method as claimed in claim 1, comprising the extraction of the sol-gel matrix contained in the or each mold from the corresponding mold.

9. The method as claimed in claim 1, comprising controlled generation of mesoporosity in the sol-gel matrix in the mold or extracted from the latter, so as to form a sol-gel matrix with hierarchical porosity, the controlled generation of mesoporosity taking place after the extraction of the or each mold from the container, and before the formation of the porous monolith from the sol-gel matrix of the or each mold.

10. The method as claimed in claim 9, wherein the formation of the porous monolith includes drying of the sol-gel matrix, whether or not extracted from the or each mold, to form a dried sol-gel matrix and/or heat treatment of the sol-gel matrix or matrices, whether or not extracted from the or each mold.

11. The method as claimed in claim 1, wherein the method excludes a step of extracting the sol-gel matrix from the or each mold, the mold being a capillary having an inside diameter d of between 5 μm and 3 mm.

12. The method as claimed in claim 1, wherein the sol-gel matrix is extracted from the mold or from each mold and the porous monolith obtained is self-supporting.

13. A self-supporting porous monolith having a largest transverse dimension d strictly smaller than 1 mm.

14. An assembly of a mold and a porous monolith filling at least one cross section of the mold, the porous monolith having a largest transverse dimension strictly greater than 200 μm, the porous monolith having been manufactured in the mold without a step of shrinking of the mold on the porous monolith.

15. A method for liquid phase chromatography, separation and/or extraction and/or adsorption of compounds of interest in complex liquid mixtures, filtration of a liquid, or catalysis of a liquid by passing the liquid through a porous monolith obtained by the method as claimed in claim 1 or a porous monolith having a largest transverse dimension d strictly smaller than 1 mm.
